(19) United States
(12) Patent Application Publication
(10) Pub. No.: US 2013/0067410 A1
(43) Pub. Date: Mar. 14, 2013

(54) VIEWING TARGET OUTPUT APPARATUS, AND OPERATION METHOD THEREOF

(71) Applicant: Yoshiori SHOJI, Tokyo (JP)

(72) Inventor: Yoshiori SHOJI, Tokyo (JP)

(73) Assignee: DWANGO, Co., Ltd., Tokyo (JP)

(21) Appl. No.: 13/605,877

(22) Filed: Sep. 6, 2012

(30) Foreign Application Priority Data
Sep. 8, 2011 (JP) 2011-196515

(51) Int. Cl. G06F 3/048

(52) U.S. Cl. 715/829

(57) ABSTRACT

In the case of the electronic book content, an operation to output the next viewing target (next output operation) such as an operation of page turning, and a predetermined operation to output the comment (comment display operation) are separately requested. Accordingly, it is necessary for the operation to output the comment to move a finger on the button for the next output operation onto a button for the comment display operation on the GUI. In order to solve the above deficiency, we provide a viewing target output apparatus having a function of placing and displaying the button for additional output operation (additional GUI button) at the position of the page-turning button on the GUI when receiving the operation input for the next output operation (next GUI button) such as the page-turning button, and displaying the next page.

### BACKGROUND OF THE INVENTION

1. Field of the Invention

The present invention relates to a technology for appropriately outputting a viewing target and additional information such as an electronic content with comment, where the additional information is correlated with the viewing target, to a viewer.

2. Description of the Related Art

Conventionally, a viewing target output apparatus for reproducing content as a viewing target including a text content such as an electronic book, a movie content, a voice (music) content has been provided. Moreover, additional information such as a comment is occasionally correlated with a part of the viewing target. Specifically, for example, comments for explaining meaning are added to technical terms in the text content, or comments of impressions posted by other viewers are added to the sequentially-reproduced movie/music content.

In the case of the text content, for example, the corresponding comment is displayed upon moving a cursor on the term, and the viewer can understand the meaning thereof. In the case of the movie/music content, the viewer can check the impression comments of other viewers after reproduction of the movie/music content, and can share the viewing impression.

Moreover, Japanese Utility Model Registration No. 3165543 discloses an electronic book system, where comments etc. added to a predetermined area in the electronic book content by a viewer using a terminal are corrected, updated and stored in an electronic book server, and the comments are distributed and displayed upon viewing the electronic book content, so that the comments are shared among the viewers, and the comments are continually corrected, updated, and stored, thereby using the page of the electronic book as a community.

As to display timing of the additional information correlated with the viewing target such as the electronic book, in addition to automatically displaying at a predetermined timing, a method, where a reception of any operation performed by the viewer triggers the display at the reception of the operation, is applicable. For example, a location in the electronic book, where the comment is added, is specified, and when the viewer moves the cursor thereon, this triggers display of the comment. Moreover, a comment display button etc. is provided separately from the content display button, and the reception of input of the comment display button triggers display of the comment (additional information).

### Related Art Documents

Patent Document 1: Japanese Utility Model Registration No. 3165543

In the above display of the additional information using a predetermined operation as a trigger, there is the following deficiency.

Therefore, an operation to output the next viewing target (next output operation) such as an operation of page turning in the case of the electronic book content, or an operation to start reproduction of the next movie/voice content in the case of the movie/voice content, and a predetermined operation to output the above additional information are separately requested. Accordingly, it is necessary for the additional output operation to move a cursor of a pointing device such as a mouse on the button for the next output operation onto a button for the additional output operation on the GUI.

### SUMMARY OF THE INVENTION

In order to solve the above deficiencies, we provide a viewing target output apparatus having a function of placing and displaying the button for additional output operation (additional GUI button) at the position of the page-turning button on the GUI when receiving the operation input for the next output operation (next GUI button) such as the page-turning button, and displaying the next page.

Specifically, an aspect of the invention provides a viewing target output apparatus, comprising a viewing target output unit, sequentially outputting a viewing target that can be correlated with additional information; a next viewing target output instruction receiver, utilizing a next GUI button for receiving an instruction to output a next viewing target; an additional viewing target output instruction receiver, utilizing an additional GUI button for receiving an instruction to output an additional viewing target; a GUI button output controller, when receiving the input via the next GUI button, outputting the additional GUI button at an approximately-same position of the next GUI button, and a method for operating such viewing target output apparatus.

Moreover, in addition to the above configuration, in another aspect of the invention provides the viewing target output apparatus, further comprising an additional information determination unit, determining whether the additional information is correlated with the viewing target; and a first operator for GUI button output controller, when it has been determined that the additional information is correlated with the next viewing target, operating the GUI button output controller to function.

Moreover, in addition to the above configuration, in another aspect of the invention provides the viewing target output apparatus, further comprising a repeated-keystroke determination unit, determining whether the next GUI button is repeatedly stroked in a state of displaying the next GUI button; and a second operator for GUI button output controller, when it has been determined by the repeated-keystroke determination unit that the repeated-stroke has been done, operating the GUI button output controller to not function.

Moreover, in addition to the above configuration, in another aspect of the invention provides the viewing target output apparatus according to any one of claims 1 to 3, further comprising a previous output instruction receiver, utilizing a previous GUI button receiving an output instruction only for a previous viewing target, wherein the previous GUI button and the next GUI button are adjacently displayed.

According to the present invention having the above configuration, when outputting the next viewing target via the next GUI button, the additional GUI button is displayed at the position of the next GUI button. Therefore, the viewer can output the additional information such as the comment by pressing the additional GUI button without moving the mouse cursor etc. placed to operate the next GUI button.

### BRIEF DESCRIPTION OF THE DRAWINGS

FIG. 1 is a diagram exemplifying a display variation of a viewing target with additional information, and each GUI button in a viewing target output apparatus of a first embodiment.

FIG. 2 is a subsequent diagram exemplifying the display variation of the viewing target with additional information, and each GUI button in the viewing target output apparatus of the first embodiment.

FIG. 3 is a functional block diagram of the viewing target output apparatus of the first embodiment.

FIG. 4 is a diagram exemplifying a management table data for explaining correlation between the viewing target and the additional information of the first embodiment.

FIG. 5 is a diagram exemplifying hardware configuration of the viewing target output apparatus of the first embodiment.

FIG. 6 is a flowchart of the viewing target output apparatus of the first embodiment.

FIG. 7 is a diagram exemplifying a display variation of a viewing target with additional information, and each GUI button in a viewing target output apparatus of a second embodiment.

FIG. 8 is a functional block diagram of the viewing target output apparatus of the second embodiment.

FIG. 9 is a flowchart of the viewing target output apparatus of the second embodiment.

FIG. 10 is a diagram exemplifying a display variation of a viewing target with additional information, and each GUI button in a viewing target output apparatus other than the second embodiment.

FIG. 11 is a functional block diagram of the viewing target output apparatus of a third embodiment.

FIG. 12 is a flowchart of the viewing target output apparatus of the third embodiment.

### DESCRIPTION OF THE PREFERRED EMBODIMENTS

Hereinafter, embodiments of the present invention will be described with reference to diagrams. The present invention is not to be limited to the above embodiments and able to be embodied in various forms without departing from the scope thereof.

The first embodiment will mainly describe claims 1, 4 and 5. The second embodiment will mainly describe claim 2. The third embodiment will mainly describe claim 3.

### First Embodiment

<Outline of First Embodiment>

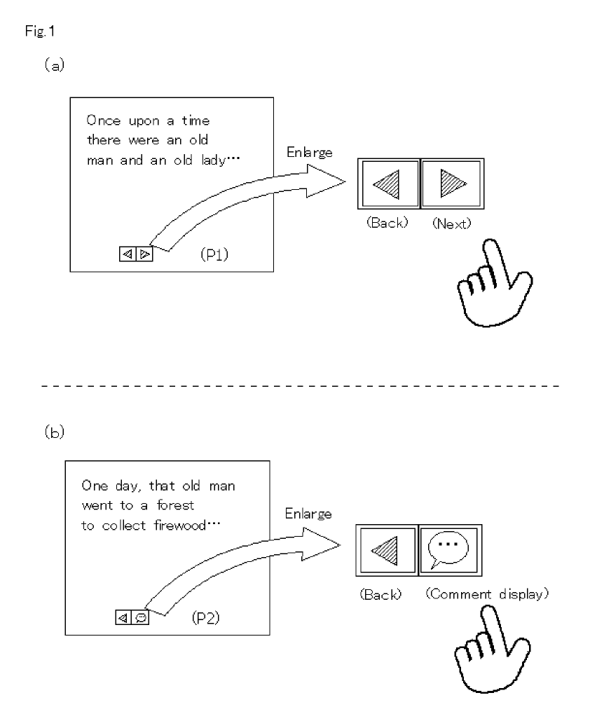

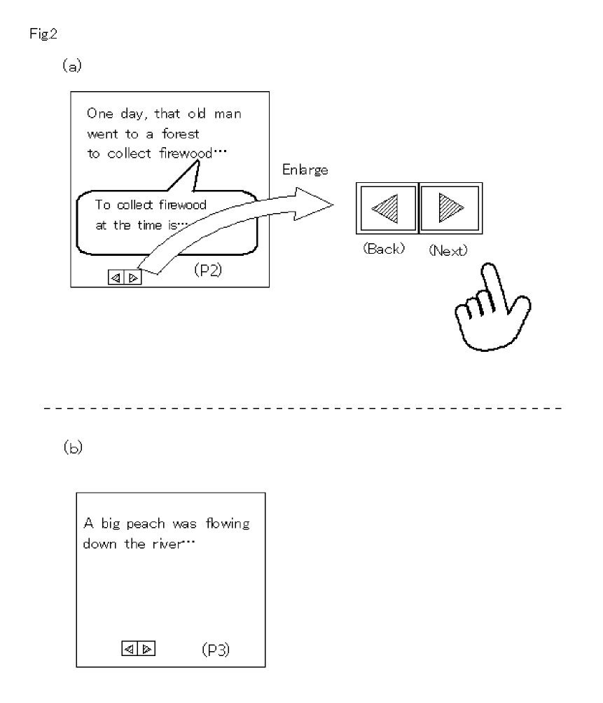

FIGS. 1 and 2 are diagrams exemplifying a display variation of the electronic book content with comment, and the GUI configured by next button (page-turning button), the back button, and the comment display button in the viewing target output apparatus of the first embodiment.

As shown in FIG. 1(a), on the display of the viewing target output apparatus of the first embodiment, the first page of the ‘defeat the ogres’ of the electronic book content, and ‘next button’ and the ‘back button’ as the GUI are displayed. Note that no comment is correlated with this first page, so that no comment is displayed. After reading the first page, the viewer moves the mouse cursor onto the ‘next button’ of the GUI on the screen, and clicks the button.

Subsequently, as shown in FIG. 1(b), on the display of the viewing target output apparatus of the first embodiment, the second page is displayed. Although comment is correlated with this second page, the comment is not displayed at this point. In the viewing target output apparatus of the first embodiment, the ‘comment display button’ is displayed at the position of the above ‘next button’ (see FIG. 1(a)) in place of the next button.

Therefore, after reading the second page, the viewer can click the ‘comment display button’ without moving the cursor from the position where the viewer has clicked the ‘next button’. Subsequently, as shown in FIG. 2(a), on the display of the viewing target output apparatus of the first embodiment, the comment ‘To collect firewood at the time is . . . ’ added to the second page is displayed in a balloon etc.

Moreover, in this state that the comment etc. is being displayed, the ‘next button’ may be displayed at the position of the above ‘comment display button’ (see FIG. 1(b)) of the GUI in place of the ‘comment display button’. Thus, the viewer can click the ‘next button’ without moving the cursor, thereby displaying the third page as shown in FIG. 2(b).

As described above, according to the viewing target output apparatus of the first embodiment, the viewer can input the output instruction of the next viewing target and the output instruction of the additional information without moving the cursor upon operation.

<Functional Configuration of First Embodiment>

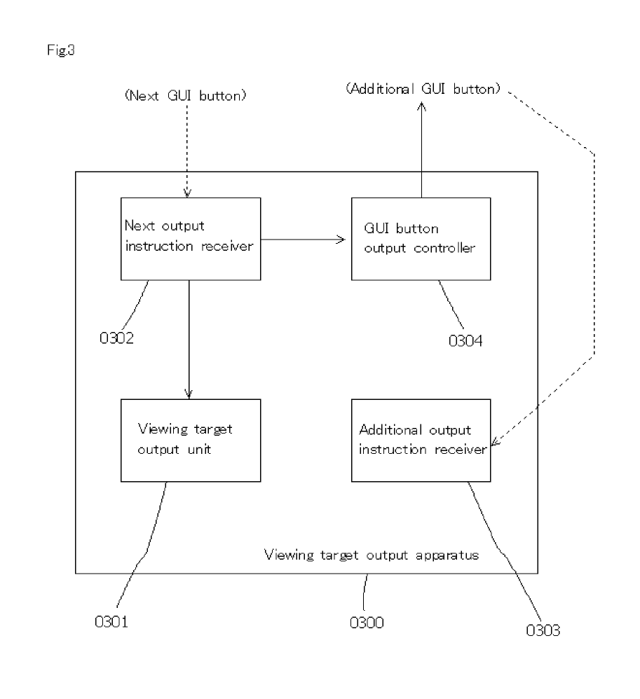

FIG. 3 is a functional block diagram of the viewing target output apparatus of the first embodiment. Note that in the viewing target output apparatus, the viewing target data and the additional information data may be loaded from an internal storage device or a portable storage device, and the apparatus can operate in stand-alone mode. Moreover, the apparatus can be connected with the network as the terminal in Japanese Utility Model Registration No. 3165543, and can acquire such data from a server on the network.

Note that, the functional block of the apparatus can be implemented by hardware, software, or both hardware and software. Specifically, in the case of using a computer, the respective units are implemented by the hardware configured by a CPU, a main memory, a bus, a secondary storage device (e.g., a hard disk or a nonvolatile memory, a storage media such as CD or DVD, or a reading drive for the above media), input device for inputting information, display device, printing device, other peripheral devices, and interface for the other peripheral devices and communication interface; and driver program for controlling the above hardware, other application programs, and application for user interface. Subsequently, the CPU executes operation in accordance with the program loaded into the main memory, so that processing, storing and outputting of the data, inputted through the input device or the interface etc. and stored in the memory of the hard disk, are carried out, and instructions to control the hardware and software are generated.

Moreover, the present invention can be implemented not only as an apparatus but also as a method thereof. Moreover, a portion of such inventions may be configured as software. Furthermore, a software product used for causing a computer to execute the software, and the recording medium, in which the software is installed, should be included in the technical scope of the present invention (the same applies throughout the entire specification).

As shown in FIG. 3, a ‘viewing target output apparatus’ of the first embodiment (0300) comprises a ‘viewing target output unit’ (0301), a ‘next viewing target output instruction receiver’ (0302), an ‘additional viewing target output instruction receiver’ (0303), and a ‘GUI button output controller’ (0304).

The ‘viewing target output unit’ (0301) has a function of sequentially outputting a viewing target that can be correlated with additional information, and can be implemented, for example, by an output apparatus and a viewing target data processing circuit (a display and an image processing circuit in the case of visual content, or a speaker and a sound processing circuit in the case of audio content), a CPU (Central Processing Unit), and a viewing target output program.

The ‘viewing target’ is content enjoyed by the viewer though visual sense of auditory sense, and an example of the content includes content configured by text data such as the electronic book, an image data, a movie data, or voice (music) data. The ‘additional information’ is information added to such viewing target, and its content, a route for addition, and data format are not limited, and any information added to the viewing target is applicable.

Examples of the additional information in the electronic book content include a comment for explaining a technical term by a writer in text format, and a picture or a movie of the place posted by a general viewer for a place name in the book. Examples of the additional information in the movie/audio content include explanation text, impression text, and links to recommended content having similar content or genre regarding the movie/audio content.

Moreover, such additional information is correlated with the viewing target, so that the additional information is outputted by reception of operating the after-mentioned additional GUI button.

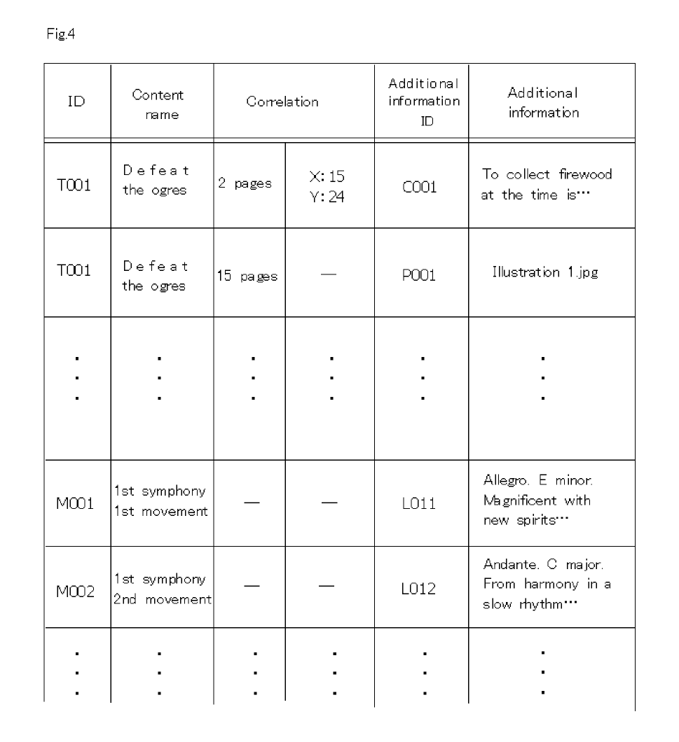

FIG. 4 is a diagram exemplifying a management table data for explaining correlation between the viewing target and the additional information of the first embodiment. As shown in FIG. 4, for example, to the text of ‘collect firewood’ at the standard coordinate (15, 24) indicated by XY coordinate system, where the upper-right position in the image file of the second page of ‘defeat the ogres’ in the electronic book content as the viewing target is origin of the coordinate system, the explanatory text ‘to collect firewood at the time is . . . ’ is correlated as the additional information. Moreover, this standard coordinate can be expressed, for example, by axial proportion coordinate, where the origin in the upper-right position in the image file is (0, 0), and a vertex coordinate in the lower-left portion in the image file is (100, 0), or by pixel coordinate value, where the image file is displayed by standard magnification (100%). Moreover, when the corresponding page is displayed by scaling, the standard coordinate value is multiplied or divided by the scaling rate, thereby specifying the coordinate correlated with the additional information after the scaling. Moreover, illustration data showing a scene where a lead character, a dog, a monkey and a pheasant start to defeat the ogres may be correlated as the additional information to the fifteenth page.

Moreover, when the viewing target is text data configured by character string, the management table data may be configured, such that the position correlated with the additional information is specified, for example, by character number in the corresponding page or character number from the top of the electronic book content. Moreover, for example, when the viewing target is a ‘cartoon’, where a page is configured by a set of a plurality of frame images, a frame number ID indicating the frame number in the entire cartoon, or positional information of the frame may be correlated with the additional information such as the comment. Moreover, when the additional information is correlated with a diagram or an illustration (not the illustration as the additional information) inserted to the other book content as the viewing target, similarly, an inserted illustration ID indicating a number of the image or the illustration in the entire content, or positional information of the image or the illustration may be correlated with the additional information.

Moreover, to the music content as the viewing target ‘1st symphony, 1st movement’, a liner note 1 ‘Allegro. E minor, Magnificent with new spirits . . . ’ is correlated as the additional information, and to ‘1st symphony, 2nd movement’, a liner note 2 ‘Andante. C major, From harmony in a slow rhythm . . . ’ is correlated as the additional information.

Note that FIG. 4 is a diagram for conceptually explaining the management of the correlation between the viewing target and the additional information, and the management may be established by a ‘relational data base’, where only the additional information ID is normally indicated in the management table data, and the correlation between the additional information ID and the additional information (e.g., text data indicating comment content) identified by the ID is indicated in the separated table data.

The viewing target output unit has a function of sequentially outputting such viewing target. The ‘sequentially outputting’ is, for example, when the viewing target is the electronic book, the output is executed page by page. Therefore, one content is outputted by a unit, where one content is divided by a predetermined amount. Moreover, when the viewing target is the movie or audio content, the second movement or the second story is outputted after the first movement or the first story. Therefore, a content group configured by a plurality of contents is set as a viewing target, and is outputted on a content basis.

For the above, the viewing target output apparatus of the first embodiment is provided with an operation button (next GUI button) for sequentially outputting the viewing target by a unit. Therefore, when the viewer wishes to view the next viewing target, the viewer is required to operate the next GUI button.

Note that it is design variation how to distinguish the unit sequentially outputted from the viewing target configured by a plurality of units, and for example, the first and second movements of FIG. 4 may be set as a part (partial unit) of the viewing target identified by the content ID ‘first symphony’, not by separated content ID.

The ‘next viewing target output instruction receiver’ (0302) is a user interface utilizing a next GUI button for receiving an instruction to output a next viewing target, and can be implemented by various input devices such as a mouse, a keyboard, a touch panel, a CPU, and a next viewing target output instruction reception program. Examples of the ‘next GUI button’ in the electronic book content include a page-turning button (GUI button for displaying the next page of the content having pages), and a scroll button (scroll bar) for moving the display area in the text. Examples of the ‘next GUI button’ in the movie/audio content include a start reproduction/skip button for the next chapter or next track.

Subsequently, when the operation input via this next GUI button is received by user's touch operation via a touch panel, or user's cursor operation via clicking mouse, the next viewing target is sequentially outputted by the function of the viewing target output unit.

Moreover, the next GUI button is configured, such that the next GUI button is placed at the approximately-same position of the after-mentioned another button (additional GUI button). Therefore, for example, it is possible to output the next GUI button at the approximately-same position of the additional GUI button by utilizing the touch panel or the button group, of which function can be varied according to a program.

The ‘additional viewing target output instruction receiver’ (0303) is a user interface utilizing an additional GUI button for receiving an instruction to output an additional viewing target, and can be implemented by various input devices such as a mouse, a keyboard, a touch panel, a CPU, and an additional viewing target output instruction reception program.

When receiving the input via the additional GUI button, the additional information is displayed on the display or though the speaker of the viewing target output apparatus. Note that the output of the additional information on the display is not limited. As shown in FIG. 2, for example, the additional information may be displayed in another window by superimposing on the displayed content, or only the additional information may be outputted after terminating the output of the content.

The ‘GUI button output controller’ (0304) has a function of outputting the additional GUI button at an approximately-same position of the next GUI button when receiving the input via the next GUI button, and can be implemented by a CPU and a GUI button output control program.

Specifically, the coordinate information on the display is acquired as the display positional information of the next GUI button, and the additional GUI button is outputted at the coordinate. Moreover, when the position of the GUI button is fixed, the control is executed, such that the function of the button at the fixed position is switched from output of the next viewing target to output of the additional information (switch of operation signal to be outputted by operation input detection), thereby implementing the GUI button output controller.

As described with reference to FIGS. 1 and 2, in the viewing target output apparatus of the first embodiment, the next viewing target is displayed according to the reception of the input via the next GUI button. Subsequently, on the GUI screen after outputting the next viewing target, the additional GUI button is outputted at the approximately-same position of the next GUI button according to the function of the GUI button output controller.

Thus, the viewing target output apparatus of the first embodiment can execute the operation inputs of the next viewing target output instruction and the additional information output instruction without making the viewer move the position of the cursor or a finger upon the operation.

<Other Functional Configuration of First Embodiment>

The viewing target output apparatus of the first embodiment may further comprise a ‘previous output instruction receiver’ is a user interface utilizing a previous GUI button for receiving an output instruction only for a previous viewing target, and as shown in FIGS. 1 and 2, the previous GUI button and the next GUI button are adjacently displayed.

The ‘previous GUI button’ is only for the output instruction for the previous viewing target such as the ‘back’ button (page-returning button), so that the additional information is not outputted by the reception of the input operation via this button. Therefore, the additional information once viewed is not displayed in a state that the previous viewing target is outputted by the previous GUI button. Therefore, the viewer does not have to view the additional information once viewed at every return operation (output operation for the previous viewing target).

<Hardware Configuration of First Embodiment>

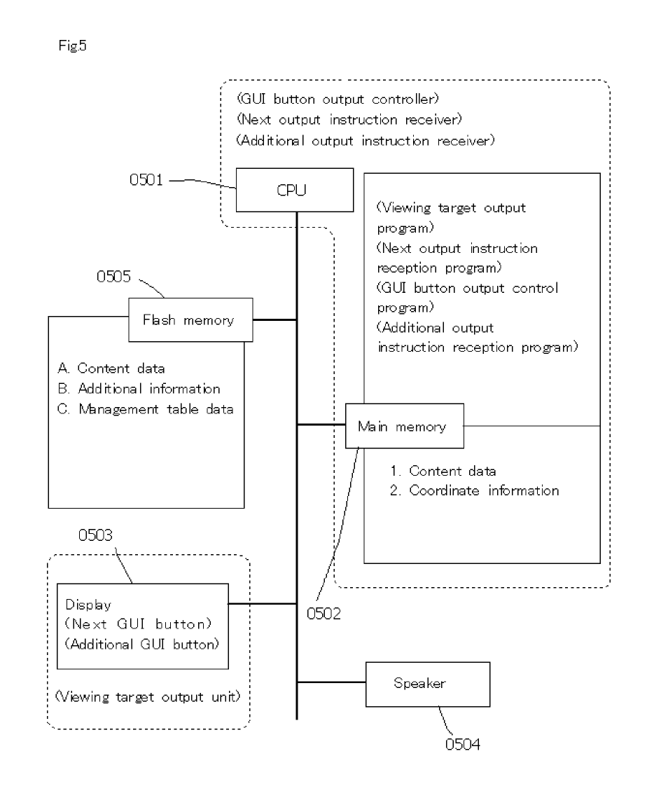

FIG. 5 is a diagram exemplifying a hardware configuration for implementing the above respective components in the viewing target output apparatus. Hereinafter, descriptions of operations of the respective hardware components in the output processing for the viewing target and the GUI button will be provided with reference to FIG. 5.

As shown in FIG. 5, the viewing target output apparatus is provided with a ‘CPU’ (0501), and a ‘main memory’ (0502). The ‘CPU’ and the ‘main memory’ calculate for executing the various processes, and implement the next viewing target output instruction receiver, the additional viewing target output instruction receiver, and the GUI button output controller. Moreover, the viewing target output apparatus is provided with a ‘display’ (0503) and a ‘speaker’ (0504) as the viewing target output unit.

Moreover, the viewing target output apparatus is provided with a ‘flash memory’ (0505) for storing the content data as the viewing target and the additional information, and the management table data indicating the correlation between the viewing target and the additional information. Moreover, when the viewing target output apparatus is connected with the network as described above, the apparatus may be provided with a ‘network connection circuit’, and the content data, the additional information, and the management table data may be stored in a server on the network. These components are mutually connected through the data communication path of ‘system bus’ or ‘communication network’, thereby carrying out transmission/reception and processing of the information.

Moreover, the programs are loaded into the ‘main memory’, and the ‘CPU’ refers to the program and executes the various calculations. Moreover, a plurality of addresses are assigned to the ‘main memory’ and the ‘flash memory’, and in the calculation by the ‘CPU’, address specification and access to the stored data are carried out, thereby executing the calculation by utilizing the data.

Subsequently, when receiving the operation input from the viewer of starting output of the content, the ‘CPU’ interprets a next output instruction reception program, and according to the result, displays the next GUI button as the GUI on the ‘display’ with the content.

Subsequently, when detecting the cursor operation for the various GUI buttons displayed on the ‘display’, it is determined according to calculation by the ‘CPU’ based on the detected position which GUI button is a target for the operation input. Subsequently, when it is determined that the operation input is for the next GUI button, the ‘CPU’ displays the next viewing target such as the next page or the next movement on the ‘display’ according to the interpretation result of the next output instruction reception program triggered by the operation input.

Subsequently, along with the above process, the ‘CPU’ interprets the GUI button output control program, and according to the result, acquire the display position (coordinate information) of the next GUI button on the display. Subsequently, the additional GUI button as the GUI is displayed at the display position on the ‘display’ with the outputted content.

Subsequently, when receiving the operation input for the additional GUI button from the viewer after reading the next page or reproduction of the movement, the ‘CPU’ interprets the additional output instruction reception program. Subsequently, by calculation according to the interpretation result, the ‘CPU’ specifies the additional information correlated with the viewing target with reference to the management table data as shown in FIG. 4 stored in the ‘flash memory, thereby displaying the specified additional information on the ‘display’. Moreover, in the state that the additional information is being displayed, the ‘CPU’ interprets the next output instruction reception program, and may display the next GUI button on the display where the additional information is being displayed.

<Processing Flow of First Embodiment>

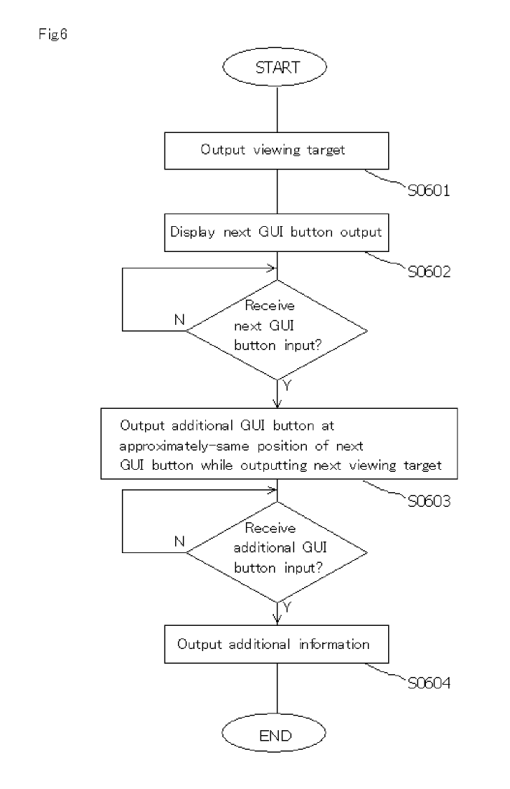

FIG. 6 is a flowchart of the viewing target output apparatus of the first embodiment. Note that, the following step may be executed by the respective hardware configurations of a computer as above, or may configure a program, which is stored in a medium and is for controlling the computer.

As shown in FIG. 6, at the outset, according to the reception via the start output button or the next GUI button for the viewing target that can be correlated with the additional information, the viewing target is outputted from the display or the speaker (step S0601). Subsequently, the next GUI button is outputted and displayed along with the output of the viewing target (step S0602). Moreover, in the step S0602, the additional GUI button is output and displayed before the display of the next GUI button irrespective of the correlation between the viewing target being displayed and the additional information, and after receiving the operation input for the additional GUI button, the next GUI button may be displayed.

After that, when receiving the operation input for the next GUI button from the viewer, while the next viewing target is outputted, the display position information of the next GUI button is acquired, thereby outputting the additional GUI button at the approximately-same position of the next GUI button (step S0603). Subsequently, according to the reception of the operation input for the additional GUI button, the additional information correlated with the viewing target being displayed is outputted (step S0604).

<Effects of First Embodiment>

According to the stage production system of the first embodiment, when outputting the next viewing target according to the reception of operation input for the next GUI button, the additional GUI button is outputted and displayed at the approximately-same position of the next GUI button. Therefore, the viewer can output the additional information such as the comment by pressing the additional GUI button without moving the cursor or the finger from the position to operate the next GUI button at the end of viewing the next viewing target.

### SECOND EMBODIMENT

<Outline of Second Embodiment>

A second embodiment on the basis of the above embodiment is a viewing target output apparatus, where when the ‘additional information is correlated’ with the next viewing target outputted in response to the operation of the next GUI button, the additional GUI button is displayed, and when the ‘additional information is not correlated’ with the next viewing target the additional GUI button is not displayed.

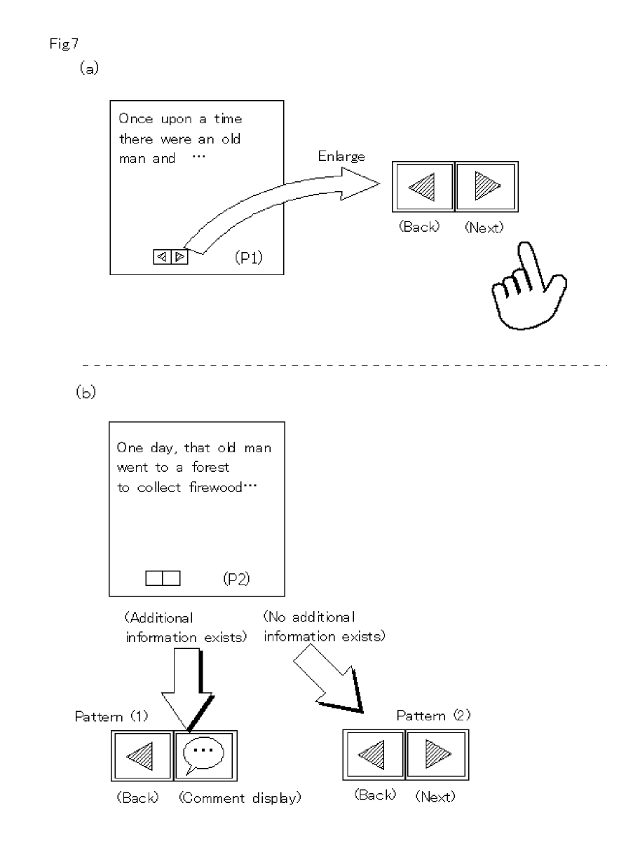

FIG. 7 is a diagram exemplifying a display variation of the viewing target with additional information, and each GUI button in the viewing target output apparatus of the second embodiment. By cursor operation for the next GUI button in the state that the viewing target in the first page is being outputted as shown in FIG. 7(a), the viewing target in the second page is displayed on the display as shown in FIG. 7(b). When the additional information is correlated with the second page, the ‘additional GUI button’ (comment display button) is displayed as shown in the GUI display pattern (1) in FIG. 7(b).

Meanwhile, when the additional information is not correlated with the second page, the additional GUI button is not displayed, and the ‘next GUI button’ (forward button) is displayed as shown in the GUI display pattern (2) in FIG. 7(b).

<Functional Configuration of Second Embodiment>

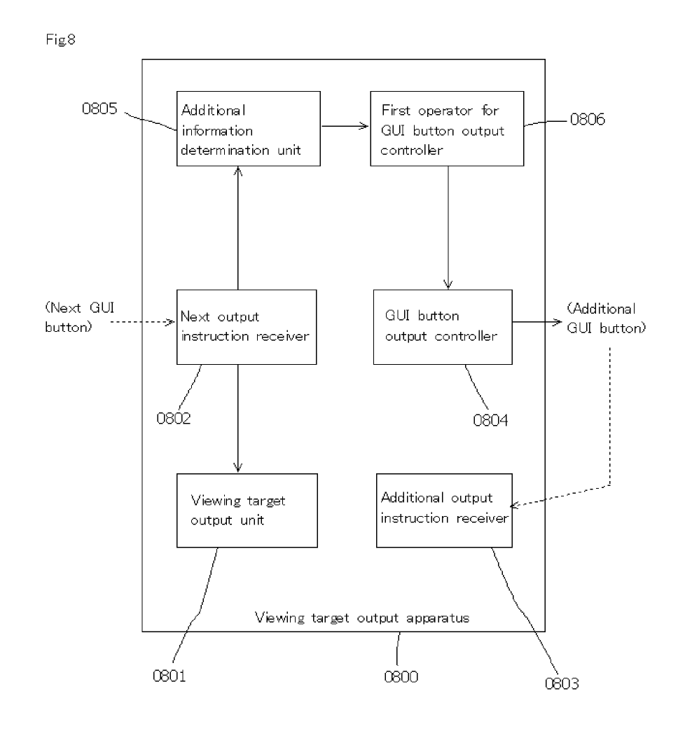

As shown in FIG. 8, a ‘viewing target output apparatus’ of the second embodiment (0800) comprises a ‘viewing target output unit’ (0801), a ‘next viewing target output instruction receiver’ (0802), an ‘additional viewing target output instruction receiver’ (0803), and a ‘GUI button output controller’ (0804). Note that the components have been described in the above embodiment, so that description thereof will be omitted.

The ‘viewing target output apparatus’ of the second embodiment further comprises an ‘additional information determination unit’ (0805) and a ‘first operator for GUI button output controller’ (0806).

The ‘additional information determination unit’ (0805) has a function of determining whether the additional information is correlated with the viewing target, and can be implemented by a CPU and an additional information determination program. Specifically, identification information (e.g., information of number of pages) of the viewing target outputted in response to the reception of the operation to start outputting the initial viewing target, or the reception of the operation via the next GUI button is acquired. Subsequently, the management table data as shown in FIG. 4 acquired from the internal storage device or the server on the network is searched by utilizing the identification information as a key, thereby determining whether the additional information is correlated.

Moreover, when the flag information indicating the correlation of the additional information is included in header information etc. of the content data as the viewing target, it may be determined whether the additional information is correlated with reference to the header information upon acquiring the viewing target.

The ‘first operator for GUI button output controller’ (0806) has a function of operating the GUI button output controller to function when it has been determined that the additional information has been correlated with the next viewing target, and can be implemented by a CPU and a first operation program for GUI button output controller.

Specifically, the CPU executes the first operation program for GUI button output controller, or outputs the execution instruction for the hardware components configuring the GUI button output controller, only when it is determined that ‘the additional information has been correlated with the next viewing target’.

Thus, in the viewing target output apparatus of the second embodiment, the additional GUI button is outputted only when the additional information has been correlated with the next viewing target. Therefore, the viewer can instantly grasp whether the additional information is correlated with the outputted viewing target by watching the display style of the GUI button. Moreover, when the additional information has not been correlated with the next viewing target. the additional GUI button is not outputted, so that the next viewing target is outputted by the viewer's operation input for the next GUI button.

<Processing Flow of Second Embodiment>

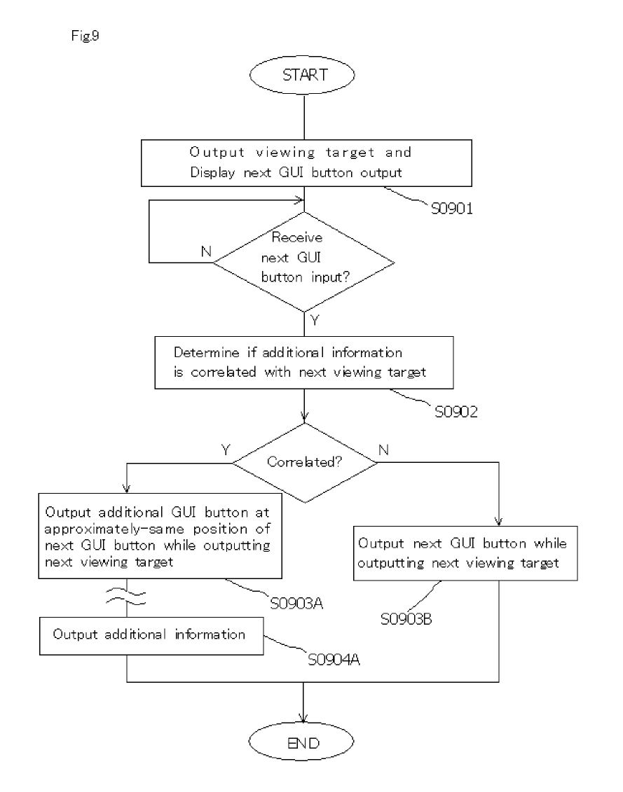

FIG. 9 is a flowchart of the viewing target output apparatus of the second embodiment. Note that, the following step may be executed by the respective hardware configurations of a computer as above, or may configure a program, which is stored in a medium and is for controlling the computer.

As shown in FIG. 9, at the outset, similar to the first embodiment, the viewing target is outputted, and the next GUI button is outputted and displayed (step S0901). Subsequently, when receiving the operation input for the next GUI button from the viewer, it is determined whether the additional information is correlated with the next viewing target, for example, with reference to the management table data or the header information of the viewing target data as shown in FIG. 4 (step S0902).

Subsequently, when it is determined that the additional information is correlated with the next viewing target, while the next viewing target is outputted, the display position information of the next GUI button is acquired, thereby outputting the additional GUI button at the approximately-same position of the next GUI button (step S0903A). Subsequently, according to the reception of the operation input for the additional GUI button, the additional information correlated with the viewing target being displayed is outputted (step S0904A).

Moreover, when it is determined that the additional information is not correlated with the next viewing target, while the next viewing target is outputted, the additional GUI button is not outputted, and the next GUI button is outputted at the same position (step S0903B).

<Effects of Second Embodiment>

According to the viewing target output apparatus of the second embodiment, when the additional information is not correlated with the viewing target, the additional GUI button is not outputted. Therefore, it is possible to output the next viewing target by the viewer's operation input for the next GUI button.

<Example of Output Control for GUI Button Other than the Second Embodiment>

Moreover, in the viewing target output apparatus of the first embodiment etc, which is not provided with the additional information determination unit and the first operator for GUI button output controller, different from the second embodiment, the additional GUI button may be outputted even when the additional information is not correlated with the viewing target.

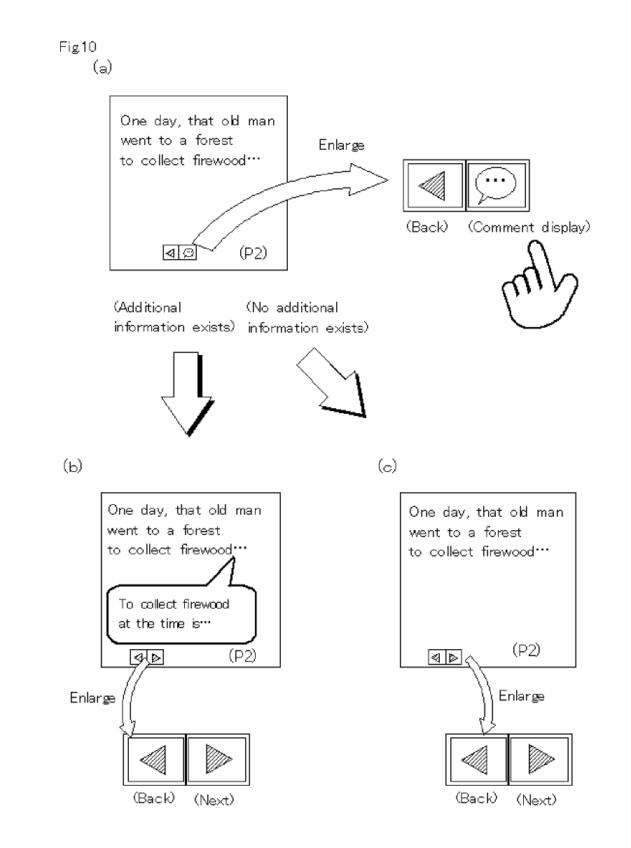

FIG. 10 is a diagram exemplifying a display variation of a viewing target with additional information, and each GUI button in a viewing target output apparatus other than the second embodiment. By cursor operation for the next GUI button in the state that the viewing target in the first page is being outputted as shown in FIG. 10(a), the viewing target in the second page is displayed on the display as shown in FIG. 10(b). Hereat, irrespective of the correlation between the additional information and the second page, the ‘additional GUI button’ (comment display button) is displayed as shown in FIG. 10.

When receiving the operation input for the additional GUI button, when the additional information exists, as shown in FIG. 10(b), the next GUI button is outputted at the approximately-same position of the additional GUI button while displaying the additional information. When the additional information does not exist, as shown in FIG. 10(c), the next GUI button is outputted at the approximately-same position of the additional GUI button without varying display.

In the above configuration, in order to output the next viewing target, it is necessary to push the additional GUI button and the next GUI button irrespective of existence of the additional information. Therefore, operations to output the next viewing target can be unified to an operation ‘press the button twice’, thereby reducing operation errors by the viewer.

Moreover, in the above configuration, an ‘additional information determination unit’ may be further comprised, and it is possible to control, such that when it is determined that the additional information is not correlated with the viewing target, the additional GUI button is displayed by gray-out etc, thereby notifying the viewer of non-existence of the additional information in viewable manner.

### THIRD EMBODIMENT

<Outline of Third Embodiment>

A third embodiment on the basis of the above embodiment is a viewing target output apparatus, where when the next GUI button is repeatedly stroked, even when the additional information is correlated with the viewing target, the next GUI button, not the additional GUI button, is outputted and displayed along with the output of the next viewing target.

<Functional Configuration of Third Embodiment>

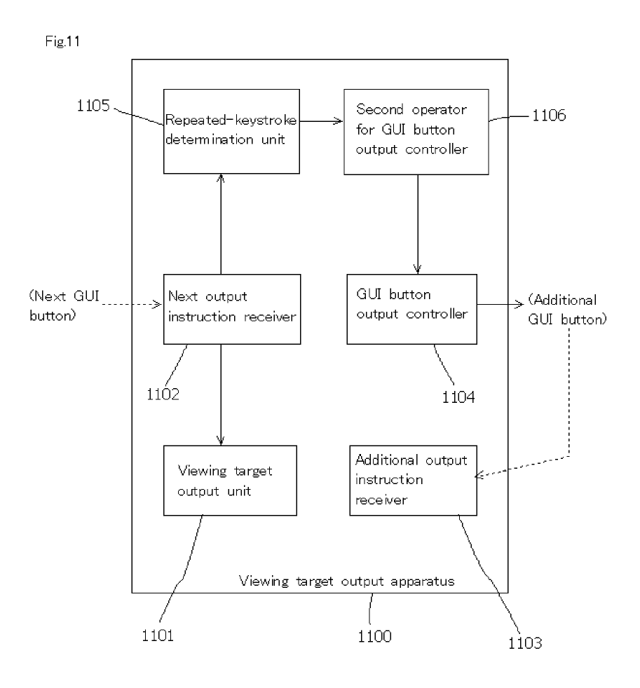

As shown in FIG. 11, a ‘viewing target output apparatus’ of the third embodiment (1100) comprises a ‘viewing target output unit’ (1101), a ‘next viewing target output instruction receiver’ (1102), an ‘additional viewing target output instruction receiver’ (1103), and a ‘GUI button output controller’ (1104). Moreover, on the basis of the second embodiment, the ‘additional information determination unit’ and the ‘first operator for GUI button output controller’, which are not indicated in figure, may be comprised. Note that the components have been described in the above embodiment, so that description thereof will be omitted.

The ‘viewing target output apparatus’ of the third embodiment further comprises a ‘repeated-keystroke determination unit’ (1105) and a ‘second operator for GUI button output controller’ (1106).

The ‘repeated-keystroke determination unit’ (1105) has a function of determining whether the next GUI button is repeatedly stroked in a state of displaying the next GUI button, and can be implemented by a CPU and a repeated-keystroke determination program. Specifically, it is determined whether a signal outputted in response to the operation input for the next GUI button is repeatedly (without other output signal) received in a predetermined time period, thereby determining existence of the repeated-keystroke.

The ‘second operator for GUI button output controller’ (1106) has a function of operating the GUI button output controller to not function when it has been determined by the repeated-keystroke determination unit that the repeated-stroke has been done, and can be implemented by a CPU and a second operation program for GUI button output controller.

Specifically, when it has been determined by the repeated-keystroke determination unit that ‘the repeated-stroke has been done for the next GUI button’, the CPU does not execute the GUI button output control program, or does not output an execute instruction for the hardware configuring the GUI button output unit, and executes the output of the next viewing target.

Thus, in the viewing target output apparatus of the third embodiment, when the next GUI button is repeatedly stroked, even when the additional information is correlated with the viewing target, the additional GUI button is not outputted. Therefore, when the viewer wishes to view only the viewing target without viewing the additional information, only the viewing target is outputted by the repeated-keystroke for the next GUI button.

<Processing Flow of Third Embodiment>

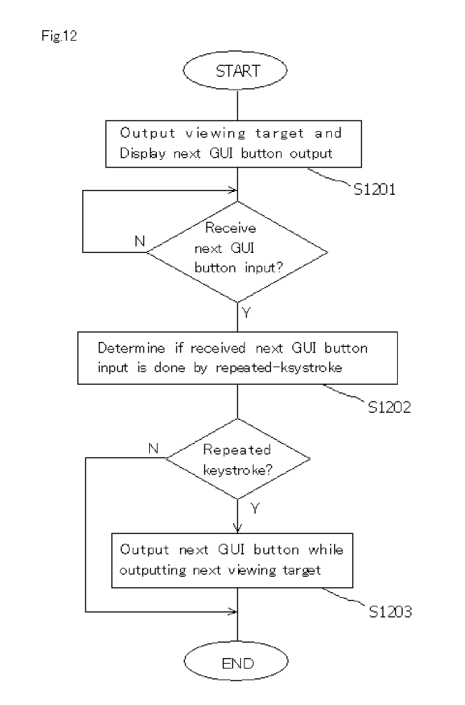

FIG. 12 is a flowchart of the viewing target output apparatus of the third embodiment. Note that, the following step may be executed by the respective hardware configurations of a computer as above, or may configure a program, which is stored in a medium and is for controlling the computer.

As shown in FIG. 12, similar to the first embodiment, at the outset, the viewing target is outputted, and the next GUI button is outputted and displayed (step S01201). Subsequently, when receiving the operation input for the next GUI button from the viewer, it is determined whether the operation input is repeated-keystroke (step S1202).

When it is determined that the operation input has been the repeated-keystroke, the next viewing target is outputted, and even when the additional information is correlated with the next viewing target, the additional GUI button is not outputted, and the next GUI button is outputted to the same position (step S1203). When it is determined that the operation input has not been the repeated-keystroke, the next viewing target is outputted, and the additional GUI button may be outputted at the approximately-same position of the next GUI button. Moreover, similar to the second embodiment, it is determined whether the additional information is correlated with the next viewing target, and it is determined that the additional information is correlated, while the next viewing target is outputted, the additional GUI button may be outputted at the approximately-same position of the next GUI button.

<Effects of Third Embodiment>

According to the viewing target output apparatus of the third embodiment, when the next GUI button is repeatedly stroked, even when the additional information is correlated with the viewing target, the additional GUI button is not outputted. Therefore, when the viewer wishes to view only the viewing target without viewing the additional information, only the viewing target is outputted by the repeated-keystroke for the next GUI button.

### DESCRIPTION OF REFERENCE NUMERALS

0300 Viewing target output apparatus

0301 Viewing target output unit

0302 Next output instruction receiver

0303 Additional output instruction receiver

0304 GUI button output controller

1. A viewing target output apparatus, comprising:
a viewing target output unit, outputting a viewing target that can be correlated with additional information;
a next viewing target output instruction receiver, utilizing a next GUI button for receiving an instruction to output a next viewing target;
an additional viewing target output instruction receiver, utilizing an additional GUI button for receiving an instruction to output an additional viewing target; and
a GUI button output controller, when receiving the input via the next GUI button, outputting the additional GUI button at an approximately-same position of the next GUI button.

2. The viewing target output apparatus according to claim 1, further comprising:
an additional information determination unit, determining whether the additional information is correlated with the viewing target; and
a first operator for GUI button output controller, when it has been determined that the additional information has been correlated with the next viewing target, operating the GUI button output controller to function.

3. The viewing target output apparatus according to claim 1, further comprising:
a repeated-keystroke determination unit, determining whether the next GUI button is repeatedly stroked in a state of displaying the next GUI button; and
a second operator for GUI button output controller, when it has been determined by the repeated-keystroke determination unit that the repeated-stroke has been done, operating the GUI button output controller to not function.

4. The viewing target output apparatus according to claim 1, further comprising:
a previous output instruction receiver, utilizing a previous GUI button receiving an output instruction only for a previous viewing target,
wherein the previous GUI button and the next GUI button are adjacently displayed.

5. A method for operating a viewing target output apparatus, comprising:
outputting a next GUI button for receiving an instruction to output a next viewing target, the next viewing target to a viewing target that can be correlated with additional information, and is outputted;
when receiving the input via the next GUI button, outputting an additional GUI button for receiving an instruction to output additional information at an approximately-same position of the next GUI button while outputting the next viewing target; and
outputting the additional information correlated with the currently-displayed viewing target according to the reception of input via the additional GUI button.

6. A method for operating a viewing target output apparatus, comprising:
outputting a next GUI button for receiving an instruction to output a next viewing target, the next viewing target to a viewing target that can be correlated with additional information, and is outputted;
when receiving the input of the next GUI button, determining whether the additional information is correlated with the viewing target;
when it has been determined that the additional information has been correlated with the next viewing target, outputting an additional GUI button for receiving an instruction to output additional information at an approximately-same position of the next GUI button while outputting the next viewing target; and
outputting the additional information correlated with the currently-displayed viewing target according to the reception of input via the additional GUI button.

7. A computer-readable storage medium storing a program for causing a computer to execute a process of operating a viewing target output apparatus, the program comprising:
outputting a next GUI button for receiving an instruction to output a next viewing target, the next viewing target to a viewing target that can be correlated with additional information, and is outputted;
when receiving the input via the next GUI button, outputting an additional GUI button for receiving an instruction to output additional information at an approximately-same position of the next GUI button while outputting the next viewing target; and
outputting the additional information correlated with the currently-displayed viewing target according to the reception of input via the additional GUI button.

8. A computer-readable storage medium storing a program for causing a computer to execute a process of operating a viewing target output apparatus, the program comprising:
outputting a next GUI button for receiving an instruction to output a next viewing target, the next viewing target to a viewing target that can be correlated with additional information, and is outputted;
when receiving the input of the next GUI button, determining whether the additional information is correlated with the viewing target;
when it has been determined that the additional information has been correlated with the next viewing target, outputting an additional GUI button for receiving an instruction to output additional information at an approximately-same position of the next GUI button while outputting the next viewing target; and
outputting the additional information correlated with the currently-displayed viewing target according to the reception of input via the additional GUI button.
